(19) United States
(12) Patent Application Publication
(10) Pub. No.: US 2008/0100192 A1
(43) Pub. Date: May 1, 2008

(54) Light Source Device With Replaceable Filament

(76) Inventors: Mang Ou-Yang, Hsinchu (TW); Shih-Wei Huang, Taipei (TW)

Correspondence Address: LIN & ASSOCIATES INTELLECTUAL PROPERTY, INC., P.O. BOX 2339, SARATOGA, CA, 95070-0339, US

(21) Appl. No.: 11/553,474

(22) Filed: Oct. 27, 2006

(51) Int. Cl. H01K 1/26

(52) U.S. Cl. 313/113

(57) ABSTRACT

A light source device with a replaceable filament comprises a light source and an envelope. The light source includes a filament tube enclosing a filament and electrodes. The filament tube further has an electrode cap and a cross electrode formed at each end thereof. The envelope includes at least one concave reflector, a light outlet, a cross electrode seat correspondingly engaged with the cross electrode of the filament tube and a positioning electrode seat for inserting the filament into the envelope and being correspondingly engaged with the electrode cape of the filament tube. The light source is easily replaced by means of inserting the light source into the envelope through the cross electrode seat. After the light source is installed in the envelope, the filament of light source is approximately aligned with the light outlet of the envelope without calibration.

### BACKGROUND OF THE INVENTION

1. Field of the Invention

The present invention relates to a light source device with a replaceable filament, and in particular to a light source device with a replaceable filament which is easy to assemble and position the filament in an envelope, and prevents contamination.

2. The Prior Arts

Basically, the principle of a projection displayer is similar to that of all projectors. The projector casts light on an image-displaying component to generate images, and then the images are projected through a lens onto a screen. The image-displaying component includes two types: a transmissive type which lets light pass through a transparent piece to project the resulting image onto the screen, and a reflective type which shines the light on an object to project the resulting image onto the screen. Both types split the light into red, green and blue, and then generate images of various colors. Because one component can display only one color, three components are required to generate three single-colored images. The three images are merged into one image through a prism, and then projected through a lens to a screen.

The light source of a video projector is similar to those employed in transparency projectors, projection displaying devices, rear projection TV's, slide projectors, light engines, automotive lamps and household lighting device; however, after years of development, problems still exist.

U.S. Pat. No. 6,356,700 discloses a projector lamp system, which employs a gas discharge lamp as a light source thereof and utilizes a hemispherical reflector and an elliptical reflector to reflect light. A filament is disposed at a focal point of the elliptical reflector, which is proximate to the surface of the elliptical reflector. The focal point is also the center of the hemispherical reflector. The hemispherical reflector reflects the light to the center thereof, which is also the focal point of the elliptical reflector. The light is then reflected to another focal point of the elliptical reflector by the elliptical reflector to be used in projection. The light collection method increases the light utilization efficiency and obtains a more even light source than those utilizing a conventional parabolic or elliptical reflector.

However, the aforementioned system has the following disadvantages. (1) When the light source is replaced, the position of the filament must be calibrated relative to the envelope, and the filament must be adjusted to be located at the focal point. (2) The replacement procedure of the light source is complicated which has to disassemble the two reflectors and calibrate the positions of the reflectors after the filament is replaced. (3) The assembly method reduces an electroplated area of the reflectors. As a result, part of the light is not collected. (4) To replace the light source, the whole device has to be disassembled, which is likely to contaminate the reflectors and the filament tube. If the reflectors or the filament tube is contaminated, the projection efficiency of the whole device will be greatly reduced. (5) The filament may not dissipate heat easily, which shortens the life thereof. (6) The requirement of a plurality of reflectors results in a higher manufacturing cost than a single-reflector envelope. (7) The double-reflector envelope has size larger than a single-reflector envelope.

In short, a light source of conventional projector employs a cup-type bulb, such as a parabolic reflector or an elliptical reflector, to collect light. The advantage of such the light source is that the filament is packaged in a light bulb, which prevents the filament from contamination. However, it has the following disadvantages. (1) The light projection is uneven. The filament tube is in the direction of the projected light, and does not emit light in an axial direction. Therefore it results in a dim area at a center of projection area. (2) The axis of projected light is in the same direction with the filament tube. It results in uneven heating of the filament. Thus, one of the electrodes of the filament may have higher energy than the other. Thermal disequilibrium causes the filament to flicker. (3) The light source has to be replaced as a unit including the cup-type reflectors, which increases the cost. (4) Due to aforementioned package of the filament, it is difficulty to dissipate heat for the light source. The possibility of explosion of the light source increases. In addition, the light source cannot be replaced immediately because of poor cooling efficiency. (5) The overheated system shortens the life of the light bulb.

To overcome these disadvantages, a highly efficient light engine is proposed, which comprises an elliptical reflector in conjunction with a hemispherical reflector. A filament is positioned at a focal point of the elliptical reflector, which is proximate to a surface of the elliptical reflector. The focal point is also a center of the hemispherical reflector. Such the light engine solves the problem of the dim area in a center of projection area and produces an even light projection. The filament is individually replaceable which greatly reduces the cost. However, the light engine has following disadvantages. (1) Because the filament is enclosed within two reflectors, the light engine has to be disassembled to replace the light source, which is likely to contaminate the reflectors and the new filament tube. Therefore, the light scatters and the light utilization efficient decreases. (2) When the filament is replaced, at least one reflector has to be disassembled. Disassembling the reflectors complicates the replacement. It is hard to calibrate after the light engine is reassembled. (3) The assembly method results in reduction of effective area of the reflector, that is, the reduction of an electroplated area of the reflector. (4) The manufacturing cost of two-reflector light engine is higher. (5) Poor heat dissipation makes the light engine more likely to explode. In addition, the light source cannot be replaced immediately because of low cooling efficiency. (6) The overheated light engine shortens the life of the light bulb.

### SUMMARY OF THE INVENTION

A primary objective of the present invention is to provide a light source device with a replaceable filament. It is easy to insert the filament into an envelope to replace the old one. Therefore, it does not need to calibrate the position of the filament relative to two reflectors of the envelope.

Another objective of the present invention is to provide a light source device with a replaceable filament including a handle. A user holds the handle when replacing the filament. Therefore the device will not be contaminated.

A further objective of the present invention is to provide a light source device with a replaceable filament, in which an envelope is an integrally molded hollow body composed of a plurality of reflectors. Hence the surface of the reflector on the envelope is increased and light utilization efficiency is enhanced.

Accordingly, the light source device with a replaceable filament in accordance with the present invention comprises a light source and an envelope. The light source includes a filament, a filament tube, and a pair of electrodes. The filament tube has the electrode at each end. The envelope, which is a hollow body composed of a plurality of reflectors, includes a cross electrode seat, a light outlet, and a positioning electrode seat.

In the light source, one of the electrodes is electrically connected with an electrode cap located at one end of the filament tube, and the other electrode is electrically connected with the cross electrode located at the other end of the filament tube. A handle is extended from the electrode cap. The filament tube is a transparent hollow tube and includes a concave portion with a specific curvature proximate to the filament. The filament tube encloses the filament and is mounted on the electrode cap.

In the envelope, the cross electrode seat is correspondingly engaged with the cross electrode of the filament tube. The positioning electrode seat provides an opening for inserting the filament of the light source into the envelope and is correspondingly engaged with the electrode cap of the filament tube.

When installing the light source and the envelope, a user holds the light source to insert the filament through the positioning electrode seat into the envelope. After the light source is completely installed in the envelope, the filament is approximately aligned with the light outlet of the envelope and a projector lens.

### BRIEF DESCRIPTION OF THE DRAWINGS

The present invention will be apparent to those skilled in the art by reading the following detailed description of a preferred embodiment thereof, with reference to the attached drawings, in which:

FIGS. 1A and 1B are schematic views of a projector having a light source device with a replaceable filament in accordance with a first embodiment of the present invention;

FIG. 2 is a schematic view of a light source device with a replaceable filament in accordance with a second embodiment of the present invention;

FIG. 3 is a schematic view of a light source device with a replaceable filament in accordance with a third embodiment of the present invention;

FIG. 4 is a schematic view of a light source device with a replaceable filament in accordance with a fourth embodiment of the present invention; and

FIGS. 5A and 5B are schematic views of a light source device with a replaceable filament in accordance with a fifth embodiment of the present invention.

### DETAILED DESCRIPTION OF THE PREFERRED EMBODIMENT

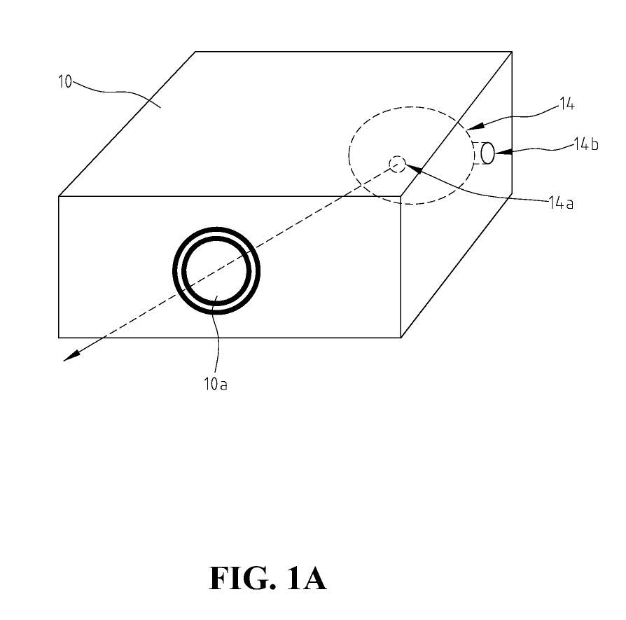

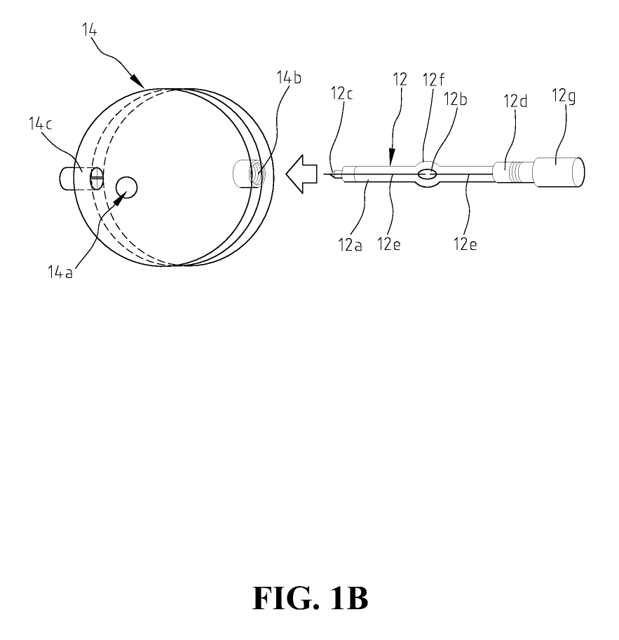

Referring to FIGS. 1A and 1B, a projector 10 comprises a light source device with a replaceable filament according to the present invention, and a projector lens 10a. The light source device comprises a light source 12 and an envelope 14. The envelope 14 is installed inside the projector 10 and has a positioning electrode seat 14b connecting the envelope 14 to outside of the projector 10.

As shown in FIG. 1B, the light source 12 includes a filament 12b, a filament tube 12a enclosing the filament 12b and a pair of electrodes 12e. The electrode 12e is extended from each end of the filament 12b. One of the electrodes 12e is electrically connected with an electrode cap 12d located at one end of the filament tube 12a and the other electrode 12e is electrically connected with a cross electrode 12c located at the other end of the filament tube 12a, respectively. A handle 12g is extended from the electrode cap 12d. The filament tube 12a is a transparent hollow tube having a concave portion 12f with a specific curvature proximate to the filament 12b. The filament tube 12a encloses the filament 12b and is mounted on the electrode cap 12d. The envelope 14, which is a hollow body composed of a plurality of reflectors, includes a light outlet 14a, a positioning electrode seat 14b, and a cross electrode seat 14c. The positioning electrode seat 14b provides an opening for inserting the filament 12b of the light source 12 into the envelope 14 and is correspondingly engaged with the electrode cap 12d of the filament tube 12a. The cross electrode seat 14c is correspondingly engaged with the cross electrode 12c of the filament tube 12a.

When installing the light source 12 with the envelope 14, a user holds the handle 12g of the light source 12 to insert the light source 12 through the positioning electrode seat 14b into the envelope 14. The filament 12b is approximately aligned with the light outlet 14a and the projector lens 10a after the light source 12 is completely installed in the envelope 14. Hence, part of light emitted by the filament 12b can directly pass through the light outlet 14a and the projector lens 10a. In addition, part of the light will be reflected by inner walls of the envelope 14 to pass through the light outlet 14a. On the other way, when replacing the light source 12, the user holds the handle 12g to remove the light source 12 in a reversed direction. The handle 12g may have a grooved or granulated surface for better gripping.

Accordingly, the light source 12 is easily replaced without disassembling the projector 10, which prevents inner components of the projector 10 from contamination. The filament 12b will not be contaminated as well since the user holds the handle 12g of the light source 12 without touching the filament 12b.

The light source 12 mentioned above may be one of a light emitting diode (LED), a laser diode (LD), other illuminators, and a light bulb or a light tube in any shape. The ends of the filament tube 12a may be covered with heat-dissipating electrodes for electrical conduction and heat dissipation.

In addition, the inner surface of the envelope 14 is a plurality of reflectors. Part of the inner surface of the envelope 14 reflects the light emitted by the light source 12 back to the filament 12b, while the other part of the inner surface reflects the light through the light outlet 14a for projection. The projector is one of a reflecting mirror a surface electroplated with a reflective material. The inner surface electroplated with a reflective material is to enhance the reflection, increase the rate of light passing through the light outlet 14a, and enhance the light utilization efficiency.

To firmly secure the light source 12 to the envelope 14, the electrode cap 12d of the light source 12 includes a fastening member for engagement with a fastening member included in the positioning electrode seat 14b of the envelope 14. The fastening members is one of a spring tenon/mortise set, a rotation tenon/mortise set, and screw threads. With the aforementioned fastening members, the relative positions of the envelope 14 and the filament 12b of the light source 12 are predetermined. When the light source 12 is inserted into the envelope 14, the positions of the filament 12b of the light source 12 and reflectors of the envelope 14 do not need to be calibrated.

In addition to the light source 12 and the envelope 14 according to a first embodiment as shown in FIGS. 1A and 1B, the envelope 14 may have different structural shapes, and components. The light source 12 may also have different designs of the filament tube 12a, especially the concave portion with a specific curvature approximate to the filament 12b.

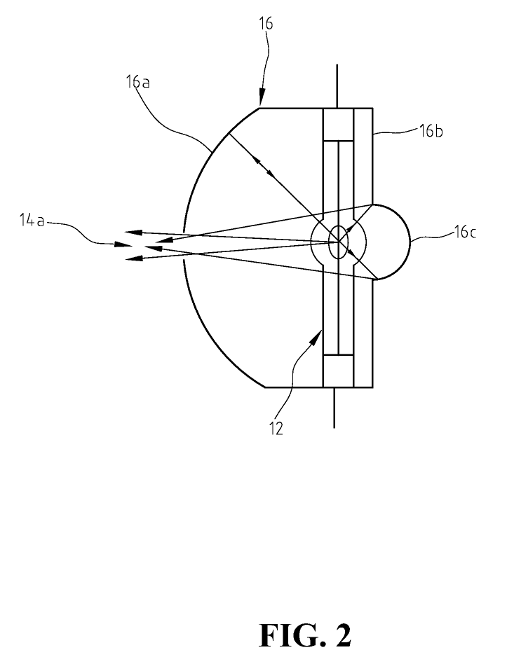

Referring to FIG. 2, a light source device with a replaceable filament in accordance with a second embodiment of the present invention comprises a light source 12 and an envelope 16.

The envelope 16 is composed of a concave reflector 16a with a specific curvature in conjunction with a planar reflector 16b having a concave reflective portion 16c with a specific curvature recessed proximate to a center of the planar reflector 16b. A light outlet 14a is provided on the concave reflector 16a, and a positioning electrode seat 14b is provided between the concave reflector 16a and the planar reflector 16b.

A primary feature of the second embodiment is that when the light source 12 is working, part of the light emitted by the filament 12b is reflected by the concave reflector 16a back to the filament 12b. Therefore, almost all the light is reflected by the concave reflective portion 16c of the planar reflector 16b, which is very close to the filament 12b, to pass through the light outlet 14a.

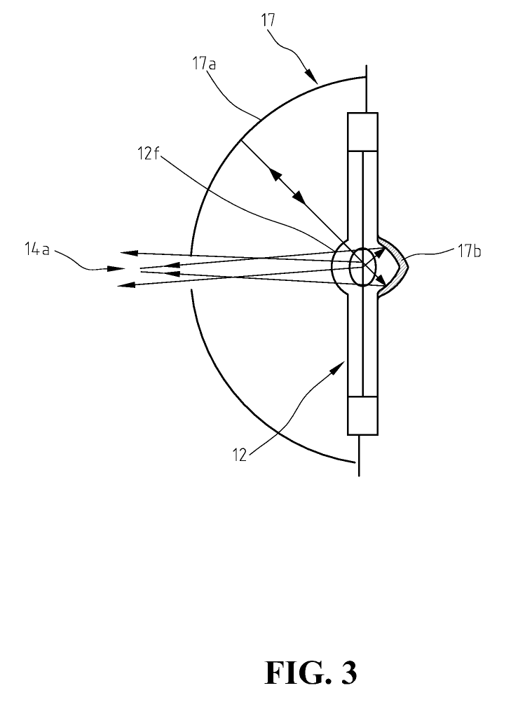

With reference to FIG. 3, a light source device with a replaceable filament in accordance a third embodiment of the present invention comprises a light source 12 and an envelope 17.

The filament tube 12a is not required in the aforementioned embodiments. It is required in the present embodiment because part of a surface of the concave portion 12f of the filament tube 12a is electroplated with a reflective material 17b to serve as a reflector.

After the light source 12 is installed and lighted in the envelope 17, a concave reflector 17a reflects the light emitted by the light source 12 back to the filament 12b. The concave portion 12f of the filament tube 12a electroplated with a reflective material 17b then reflects the light emitted by the light source 12 through the light outlet 14a of the concave reflector 17a.

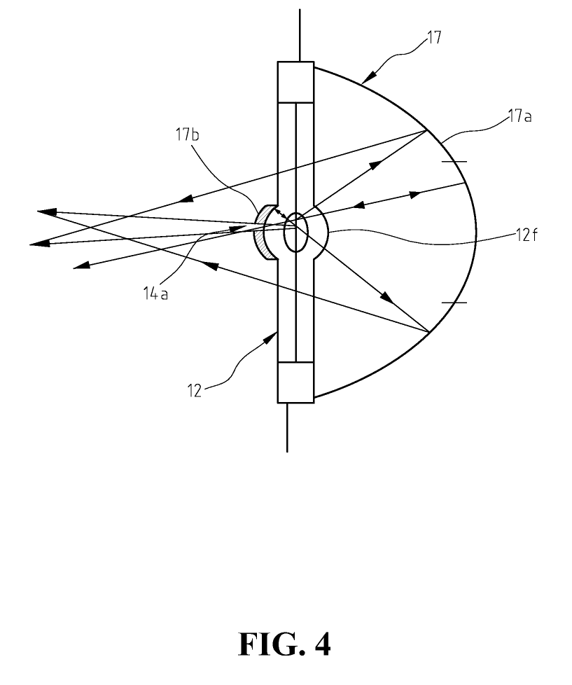

With reference to FIG. 4, a light source device with a replaceable filament in accordance with a fourth embodiment of the present invention comprises a light source 12 and an envelope 17.

Similar to the third embodiment, the concave portion 12f of the filament tube 12a has a reflective material 17b electroplated on part of a surface thereof. One of the differences between these two embodiments is that the light outlet 14a is defined on envelope 17 in third embodiment while the light outlet 14a is defined on the reflective material 17b electroplated on the concave portion 12f in the fourth embodiment. Another difference is that the reflective material 17b is electroplated at opposite sides on the concave portion 12f in the third and fourth embodiments.

When the light source 12 is working, part of the light emitted by the filament 12b passes through the light outlet 14a directly. Besides, the reflective material 17b electroplated on the concave portion 12f of the filament tube 12a reflects part of the light emitted by the filament 12b to the concave reflector 17a of the envelope 17, and then the concave reflector 17a projects the light forward to the projector lens 10a.

In both the third and the fourth embodiments, a reflecting mirror may replace the reflective material 17b electroplated on part of the concave portion 12f of the filament tube 12a to obtain the same effect.

Regarding to the methods of installing the light source 12 to the envelope 14, 16, 17, in addition to the aforementioned horizontal insertion methods, the structure of the envelope 14, 16, 17 and the projector 10 may be slightly adjusted to allow vertical installation.

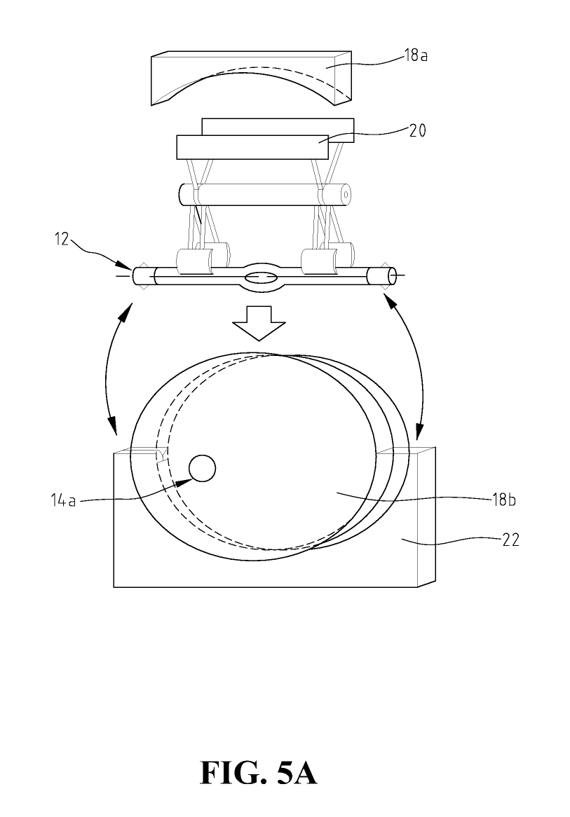

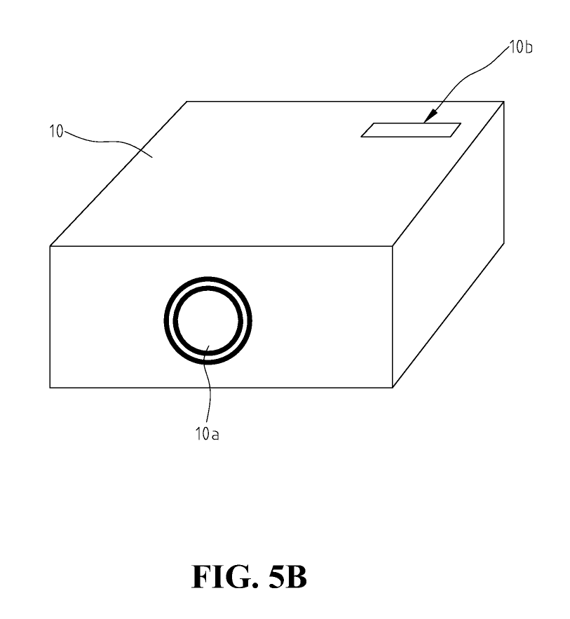

With reference to FIGS. 5A and 5B, a light source device with a replaceable filament in accordance with a fifth embodiment of the present invention comprises a light source 12, an envelope 18b for receiving the light source 12 and a lid 18a capped on the envelope 18b. As shown in FIG. 5B, the envelope 18b is mounted in a projector 10 and corresponding to an opening 10b of the projector 10. The upper part of the envelope 18b provides an envelope opening to allow the light source 12 to enter. The envelope opening on the envelope 18b is completely covered by the lid 18a.

When installing the light source 12 into the envelope 18b, the user may use a clamp 20 to hold the light source 12, and insert the light source 12 through the opening 10b of the projector 10 into the envelope 18b. Both electrodes at ends of the light source 12 are electrically connected to an electrode holder 22.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A light source device with a replaceable filament, comprising
a light source including a filament, a filament tube enclosing the filament, an electrode extended from each end of the filament in which one electrode electrically connected with an electrode cap located at one end of the filament tube and the other electrode electrically connected with a cross electrode located at the other end of the filament tube respectively, and a handle extended from the electrode cap, wherein the filament tube is a transparent hollow tube having a concave portion with a specific curvature proximate to the filament, encloses the filament and is mounted on the electrode cap; and
an envelope which is a hollow body composed of a plurality of reflectors, including a light outlet, a cross electrode seat correspondingly engaged with the cross electrode of the filament tube, and a positioning electrode seat for inserting the filament into the envelope and being correspondingly engaged with the electrode cap of the filament tube;
wherein the handle is held by a user for inserting the filament into the envelope, and the filament is approximately aligned with the light outlet of the envelope after the filament is installed in the envelope.

2. The light source device as claimed in claim 1, wherein an inner surface of the envelope is a concave surface with a specific curvature.

3. The light source device as claimed in claim 1, wherein the reflector is one of a reflecting mirror and a surface electroplated with a reflective material.

4. The light source device as claimed in claim 1, wherein the electrode cap of the light source includes a fastening member for engagement with a fastening member included in the positioning electrode seat of the envelope for fastening the light source to the envelope.

5. The light source device as claimed in claim 4, wherein the fastening members are one of a spring tenon/mortise set, a rotation tenon/mortise set, and screw threads.

6. The light source device as claimed in claim 1, wherein the light source is one of a light emitting diode (LED), a laser diode (LD), a light bulb and a light tube.

7. The light source device as claimed in claim 1, wherein the handle has one of a grooved surface and a granulated surface.

8. A light source device with a replaceable filament, comprising
a light source including a filament, a filament tube enclosing the filament, an electrode extended from each end of the filament in which one electrode electrically connected with an electrode cap located at one end of the filament tube and the other electrode electrically connected with a cross electrode located at the other end of the filament tube respectively, and a handle extended from the electrode cap, wherein the filament tube is a transparent hollow tube having a concave portion with a specific curvature proximate to the filament, encloses the filament and is mounted on the electrode cap; and
an envelope, which is composed of a concave reflector in conjunction with a planar reflector having a concave reflective portion recessed proximate to a center of the planar reflector, including a light outlet provided on the concave reflector, a cross electrode seat correspondingly engaged with the cross electrode of the filament tube, and a positioning electrode seat located between the concave reflector and the planar reflector for inserting the filament into the envelope and being correspondingly engaged with the electrode cap of the filament tube;
wherein the handle is held by a user for inserting the filament into the envelope, and the filament is approximately aligned with the light outlet of the envelope after the filament is installed in the envelope.

9. The light source device as claimed in claim 8, wherein the reflector is one of a reflecting mirror and a surface electroplated with a reflective material.

10. The light source device as claimed in claim 8, wherein the electrode cap of the light source includes a fastening member for engagement with a fastening member included in the positioning electrode seat of the envelope for fastening the light source to the envelope.

11. The light source device as claimed in claim 10, wherein the fastening members are one of a spring tenon/mortise set, a rotation tenon/mortise set, and screw threads.

12. The light source device as claimed in claim 8, wherein the light source is one of a light emitting diode (LED), a laser diode (LD), a light bulb and a light tube.

13. The light source device as claimed in claim 8, wherein the handle has one of a grooved surface and a granulated surface.

14. A light source device with a replaceable filament, comprising
a light source including a filament, a filament tube enclosing the filament, an electrode extended from each end of the filament in which one electrode electrically connected with an electrode cap located at one end of the filament tube and the other electrode electrically connected with a cross electrode located at the other end of the filament tube respectively, and a handle extended from the electrode cap, wherein the filament tube is a transparent hollow tube having a concave portion with a specific curvature proximate to the filament, part of the concave portion is a reflector and the filament tube encloses the filament and is mounted on the electrode cap; and
an envelope, which is composed of a concave reflector with a specific curvature, including a light outlet provided on the concave reflector, a cross electrode seat correspondingly engaged with the cross electrode of the filament tube and a positioning electrode seat located at a periphery of the concave reflector for inserting the filament into the envelope and being correspondingly engaged with the electrode cap of the filament tube;
wherein the handle is held by a user for inserting the filament into the envelope, the filament is approximately aligned with the light outlet of the envelope after the filament is installed in the envelope, and the reflector on the concave portion reflects the light emitted by the filament through the light outlet.

15. The light source device as claimed in claim 14, wherein the reflector on the concave portion of the filament tube is one of a reflecting mirror and a surface electroplated with a reflective material.

16. The light source device as claimed in claim 14, wherein the concave reflector of the envelope is one of a reflecting mirror and a surface electroplated with a reflective material.

17. The light source device as claimed in claim 14, wherein the electrode cap of the light source includes a fastening member for engagement with a fastening member included in the positioning electrode seat of the envelope for fastening the light source to the envelope.

18. The light source device as claimed in claim 17, wherein the fastening members are one of a spring tenon/mortise set, a rotation tenon/mortise set, and screw threads.

19. The light source device as claimed in claim 14, wherein the light source is one of a light emitting diode (LED), a laser diode (LD), a light bulb and a light tube.

20. The light source device as claimed in claim 14, wherein the handle has one of a grooved surface and a granulated surface.

21. A light source device with a replaceable filament, comprising
a light source including a filament, a filament tube enclosing the filament, an electrode extended from each end of the filament in which one electrode electrically connected with an electrode cap located at one end of the filament tube and the other electrode electrically connected with a cross electrode located at the other end of the filament tube respectively, and a handle extended from the electrode cap, wherein the filament tube is a transparent hollow tube having a concave portion with a specific curvature proximate to the filament, and part of the concave portion is a reflector having a light outlet defined thereon; and
an envelope which is composed of a concave reflector with a specific curvature, including a cross electrode seat correspondingly engaged with the cross electrode of the filament tube and a positioning electrode seat, located at a periphery of the concave reflector for inserting the filament into the envelope and being correspondingly engaged with the electrode cap of the filament tube;
wherein the handle is held by a user for inserting the filament into the envelope, part of light emitted by the filament is directly projected out through the light outlet, part of light emitted by the filament is reflected to the concave reflector by the reflector of the concave portion of the filament tube, and the concave reflector reflects the light out of the light source device.

22. The light source device as claimed in claim 21, wherein the reflector of the concave portion is one of a reflecting mirror and a surface electroplated with a reflective material.

23. The light source device as claimed in claim 21, wherein the concave reflector of the envelope is one of a reflecting mirror and a surface electroplated with a reflective material.

24. The light source device as claimed in claim 21, wherein the electrode cap of the light source includes a fastening member for engagement with a fastening member included in the positioning electrode seat of the envelope for fastening the light source to the envelope.

25. The light source device as claimed in claim 24, wherein the fastening members are one of a spring tenon/mortise set, a rotation tenon/mortise set, and screw threads.

26. The light source device as claimed in claim 21, wherein the light source is one of a light emitting diode (LED), a laser diode (LD), a light bulb and a light tube

27. The light source device as claimed in claim 21, wherein the handle has one of a grooved surface and a granulated surface.
